(19) United States
(12) Patent Application Publication
(10) Pub. No.: US 2026/0148497 A1
(43) Pub. Date: May 28, 2026

(54) SINGLE-VIEW BODY MESH LEARNING THROUGH ACCURATE DEPTH ESTIMATION

(71) Applicant: NVIDIA Corp., Santa Clara, CA (US)

(72) Inventors: Shengze Wang, Durham, NC (US); Jiefeng Li, Shanghai (CN); Tianye Li, Cupertino, CA (US); Ye Yuan, Cupertino, CA (US); Koki Nagano, Los Angeles, CA (US); Shalini De Mello, San Francisco, CA (US); Michael Stengel, San Jose, CA (US)

(73) Assignee: NVIDIA Corp., Santa Clara, CA (US)

(21) Appl. No.: 19/393,354

(22) Filed: Nov. 18, 2025

Related U.S. Application Data
(60) Provisional application No. 63/725,925, filed on Nov. 27, 2024.

(51) Int. Cl. G06T 17/20; G06T 7/50; G06T 7/73; G06T 7/80

(52) U.S. Cl. CPC G06T 17/20; G06T 7/50; G06T 7/75; G06T 7/80; G06T 2200/04; G06T 2207/20084; G06T 2207/30196

(57) ABSTRACT

Systems including a pelvis depth estimation model configured to generate a pelvis depth estimate of a person depicted in an image, a human mesh estimation model configured to generate a body mesh corresponding to the person depicted in the image given the estimated pelvis depth, and a camera solver configured to apply differentiable rasterization to derive camera parameters for the image.

### CROSS-REFERENCE TO RELATED APPLICATIONS

This application claims priority and benefit under 35 U.S.C. 119 (e) to U.S. Application No. 63/725,925, “Single-View Body Mesh Learning through Accurate Depth Estimation”, filed on Nov. 27, 2024, the contents of which are incorporated herein by reference in their entirety.

### BACKGROUND

Single-image human mesh recovery is a challenging task due to the ill-posed nature of simultaneous body shape, pose, and camera estimation. Existing estimators work well on images taken from afar, but may break down as the person depicted in the image becomes closer to the camera. Conventional mechanisms may fail to achieve simultaneous three-dimensional (3D) human mesh estimation and two-dimensional (2D) alignment to the input image with sufficient accuracy. Error may arise from inaccurate camera parameters which are often heuristically derived from orthographic parameters and/or orthographic assumptions.

Conventional mechanisms may estimate a pose of the person depicted in the image from image crops, leading to pose inaccuracy compared to the ground truth. Focal length and 3D translation (f, T) may be heuristically converted from orthographic parameters, a 2D affine transformation (s, tₓ, t_{y}) that may produce unsuitable results for close-range depictions.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of a system for determining a human mesh and camera parameters from a single original image depicting a person.

FIG. 2 depicts a parallel processing unit in accordance with one embodiment.

FIG. 3 depicts a general processing cluster in accordance with one embodiment.

FIG. 4 depicts a memory partition unit in accordance with one embodiment.

FIG. 5 depicts a streaming multiprocessor in accordance with one embodiment.

FIG. 6 depicts a processing system in accordance with one embodiment.

FIG. 7 depicts an exemplary processing system in accordance with another embodiment.

FIG. 8 illustrates an exemplary data center 800, in accordance with at least one embodiment.

### DETAILED DESCRIPTION

Disclosed herein and mechanisms for accurate human mesh and camera parameter estimation from single-view in-the-wild images including close-ups with high levels of perspective distortion.

Generally, people are depicted in images at different focal lengths and Z-translations T_{z} from the camera. Changing the focal length, e.g. increasing or decreasing from a focal length f₁ to focal length f₂, changes the zoom factor but does not change the perspective distortion. Changing the Z-translation by a ΔT_{z} changes the level of perspective distortion in the image. This effect is particularly pronounced for close-range depictions.

The disclosed mechanisms accurately recover perspective parameters from a single image without heuristic assumptions. Based on the inverse relationship between the amount of perspective distortion in the image and the Z translation T_{z} of the depicted person, T_{z} may be reliably estimated from the image. The estimated T_{z} may be applied to human mesh recovery for close-range depictions. Once T_{z} and a 3D human mesh and its orientation are estimated, the camera focal length and the full 3D translation of the depicted person may be accurately determined.

A T_{z} estimator model may be trained and otherwise configured to predict the pelvis depth of a person depicted in an image with respect to the camera. The value of T_{z} affects the perspective distortion of a mesh estimated from the image. A human mesh estimator may be conditioned on T_{z} in order to improve accuracy of a human mesh estimated from the image. The camera focal length f and remaining X-axis and Y-axis translation parameters Tₓ and T_{y} may be determined through differentiable rasterization which utilizes T_{z} and the 3D human mesh and orientation.

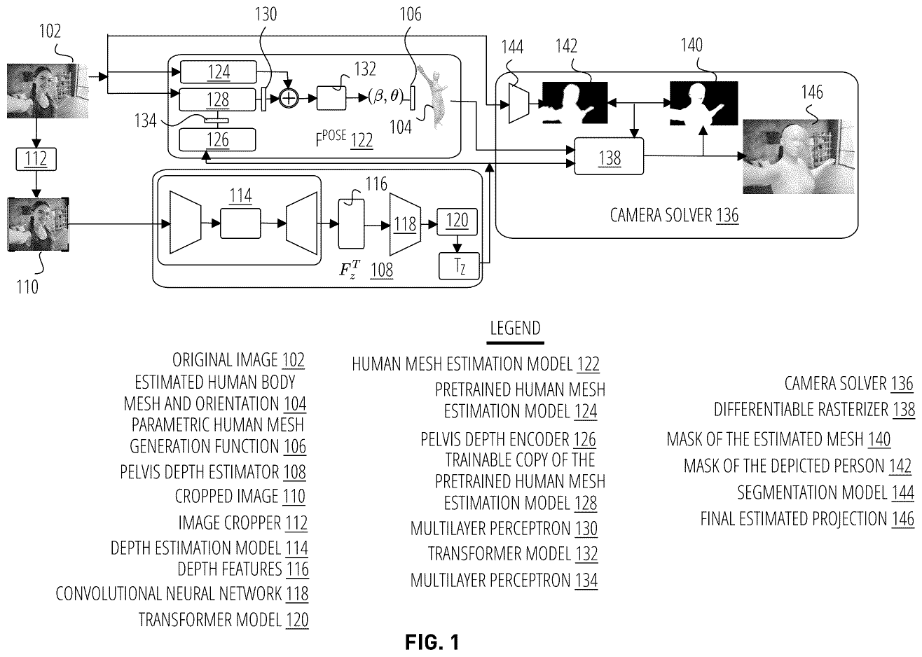

FIG. 1 depicts an embodiment of a system for determining a human mesh and camera parameters from a single original image 102 depicting a person. A common pinhole camera model with principal points at the center of the image is assumed. From the initial condition (f, Tₓ, T_{y})=[h, 0, 0] and the estimated T₂ and human mesh parameters (β, θ), the final (f, Tₓ, T_{y}, T_{z}) parameters may be determined by optimizing image space alignment through differentiable rasterization. The determined parameters align a projected 3D human mesh to a person depicted in the original image 102. The 3D human mesh translation (Tₓ, T_{y}, T_{z}) and orientation parameters (comprised by θ) are with respect to the camera-centric coordinate system, where the camera is assumed to be at the origin and have no rotation, i.e. rotation matrix is identity.

First, a Z-translation T_{z} of a person depicted in an image with respect to the camera is determined. Next, a 3D human pose and shape (β, θ) are determined, where θ comprises the orientation of the 3D human mesh in the camera coordinate system. The depicted person's XY-translations (Tₓ, T_{y}) and the camera focal length f may then be determined from the Z-translation, pose, and shape.

The system depicted in FIG. 1 generates an accurate estimated human body mesh and orientation 104 for a person depicted in the original image 102 in the form of a 3D parametric body model (e.g., the SMPL-X body model) while simultaneously performing 2D alignment between the person depicted in the original image 102 and the estimated human body mesh and orientation 104.

The system comprises a parametric human mesh generation function 106 implementing a differentiable function M(β, θ) that transforms the pose parameters θ and the shape parameters β into an estimated human body mesh and orientation 104 comprising M∈R^{N×3} vertices and J∈R^{K×3} joint locations. The shape parameters, e.g., β∈R¹⁰, may comprise a first number (PCAₙ, e.g., n=10) of Principle Component Analysis coefficients to model body shape variations. The pose parameters θ∈R^{K×3} model the joint rotation including the body orientation, which is the same as the mesh's orientation in the camera coordinate system in this case. The camera space coordinates of SMPL-X vertices [xₘ, yₘ, zₘ] may be obtained by:

$$[ x , y , z ] = [ {x}_{m} , {y}_{m} , {z}_{m} ] + [ {T}_{x} , {T}_{y} , {T}_{z} ] \qquad ( 1 )$$

where T=[Tₓ, T_{y}, T_{z}] is the position of the depicted person's pelvis in the camera coordinate. The vertices [xₘ, yₘ, zₘ] take into account the rotation of the human body in camera space. With perspective projection, the projected coordinates may be determined by:

$$[ \begin{matrix}u \\ v\end{matrix} ] = f \cdot [ \begin{matrix}x / z \\ y / z\end{matrix} ] = f \cdot [ \begin{matrix}( {x}_{m} + {T}_{x} ) / ( {z}_{m} + {T}_{z )} \\ ( {y}_{m} + {T}_{y} ) / ( {z}_{m} + {T}_{z} )\end{matrix} ] \qquad ( 2 )$$

Per Equation 2, the projected image coordinates are globally linear with respect to the camera focal length f, indicating that focal length may be treated as a uniform scaling parameter that does not affect perspective distortion. However the Z-distance T_{z} and 3D geometry (pose and shape) influence the position zₘ and assert a nonlinear impact on the projected image.

Perspective distortion, defined as the difference between perspective and orthographic projection, decreases as T_{z} increases, whereas perspective distortion rapidly increases as T_{z} decreases at close ranges (e.g., ranges under one meter). Therefore, the amount of perspective distortion observed in an image is strongly correlated to the depicted subject's Z-distance T_{z} to the camera and may be utilized to reliably estimate T_{z} directly from the image.

The same person and pose may result in significantly different projections in the image depending on T_{z}. When estimating the 3D mesh of a person depicted in an image, the influence of T_{z} may be substantial.

The disclosed mechanisms comprise a pelvis depth estimator 108 (T_{z}=F^{T}^{_{z}}(I_{crop})) that estimates the depth of a depicted person's pelvis from a cropped image 110 (I_{crop}). The cropped image 110 may be obtained by processing the original image 102 through an image cropper 112 (e.g., any of a number of well-known software applications or algorithms for cropping images). The pelvis depth estimator 108 may utilize a pretrained monocular depth estimation model 114 such as Depth Anything (e.g., v2) as a backbone to extract depth features 116 from I_{crop}. Suitable depth estimation models 114 other than Depth Anything that are known in the art may be utilized as well.

To estimate the pelvis depth T_{z} the extracted depth features 116 may be processed through a trainable convolutional neural network 118 followed by a transformer model 120. Depth may in theory increase to infinity making it impractical to accurately predict depth across the entire theoretical range due to the model's inherently limited learning capacity.

The disclosed mechanisms may therefore be configured (trained) to achieve accurate depth prediction for a limited depth range of the depicted subject, e.g., 0<T_{z}<1.2 m, where perspective distortion tends to manifest more strongly. The accuracy of estimation depth is less important as the person becomes farther away from the camera because the depicted images become more and more similar to orthographic projection at further depths. This configuration of the model may be implemented during training of the pelvis depth estimator 108 F^{T}^{_{z}} by weighting the T_{z} error inversely in proportion to a ground truth depth

$${T}_{z}^{GT}$$

weighted L1 depth loss:

$${L}_{depth} = 1 / {T}_{z}^{GT} \cdot {‖ {T}_{z} - {T}_{z}^{GT} ‖}_{1} \qquad ( 3 )$$

The depth estimate T_{z} affects the accuracy of human mesh estimation. Therefore, the T_{z}-aware human mesh estimation model 122 F^{pose} utilizes both the cropped image 110 and the estimated T_{z} to predict the estimated human body mesh and orientation 104, for example as SMPL-X parameters (β, θ).

A conventional pretrained human mesh estimation model such as AiOS (AiOS: All-in-One-Stage Expressive Human Pose and Shape Estimation”, by Sun et al., published 2024) may be ill-suited for generating estimated human body mesh and orientations 104 for people depicted in the full original image 102 at close-range with strong perspective distortion. Furthermore, naively fine-tuning a conventional pretrained pose estimation model with close-range datasets may result in over-fitting and undermine the model's generalizability.

To achieve both generalizability and T_{z}-awareness, the human mesh estimation model 122 F^{pose} may retain the configuration of the pretrained human mesh estimation model 124 while injecting additional depth information T_{z}=F^{T}^{_{z}} (I) through a ControlNet-style pelvis depth encoder 126. The pretrained human mesh estimation model 124 parameters may be frozen and a trainable copy of the pretrained human mesh estimation model 128 may have its parameters configured during training. A ControlNet is a neural network structure known in the art that enables a model to generate outputs with control signals other than those that the original model was trained to use.

The trainable copy of the pretrained human mesh estimation model 128 may be initialized with parameters (e.g., weights) from the pretrained human mesh estimation model 124. Output of the trainable copy of the pretrained human mesh estimation model 128 may be processed through a zero-initialized multilayer perceptron 130 before being added (or otherwise combined, e.g., by averaging) with output from the pretrained human mesh estimation model 124 and transformed into the (B, θ) parameters by a transformer model 132. Before training of the trainable copy of the pretrained human mesh estimation model 128 begins, the zero-initialized multilayer perceptron 130 generates a zero residual to ensure similar performance to the human mesh estimation model 122 using the pretrained human mesh estimation model 124.

Once training starts, the zero-initialized multilayer perceptron 130 may transition to nonzero status and enable the trainable copy of the pretrained human mesh estimation model 128 to improve upon the predictions of the pretrained human mesh estimation model 124.

To condition the human mesh estimation model 122 on T_{z}, a plurality (e.g., a pair) of multilayer perceptrons 134 may be utilized to encode T_{z} into deep features. These T_{z} features may be injected into the trainable copy of the pretrained human mesh estimation model 128 by summing them with the trainable copy of the pretrained human mesh estimation model 128 encoder features. Utilizing this structure and process, the pose estimation capability of the pretrained human mesh estimation model 124 is retained while the trainable copy of the pretrained human mesh estimation model 128 acquires additional understanding of how T_{z} distance affects the appearance of the human body in close-range depictions.

The predicted shape and pose parameters (β, θ) may be applied to a parametric human mesh generation function 106 such as SMPL-X to obtain the vertices V and joints J of the estimated human body mesh and orientation 104 located at the origin:

$$( β , θ ) = {F}^{pose} ( I ⋁ {T}_{z} )$$

$$( V , J ) = M ( β , θ )$$

where M is a parametric human mesh generation function such as SMPL-X. To supervise the estimation of human shape, a shape loss Lₛₕₐₚₑ may be determined as the L1 distance between the ground truth shape weights β_{GT} and predicted shape parameters β:

$${L}_{shape} = L 1 ( β , {β}_{GT} ) \qquad ( 4 )$$

To supervise the estimation of pose parameters, an angular error may be determined between the predicted joint rotations θ and ground truth joint rotations θ_{GT} (including the root joint orientation):

$${L}_{pose} = {E}_{ang} ( θ , {θ}_{GT} ) \qquad ( 5 )$$

The positions of the estimated joints may be supervised using a joint location loss Lⱼₒᵢₙₜ as the L1 distance between the predicted joint locations J and ground truth joint locations J_{GT}:

$${L}_{joint} = {L}_{1} ( J , {J}_{GT} ) \qquad ( 6 )$$

The prediction of the mesh vertices may be supervised by calculating the vertex loss Lᵥₑᵣₜ as the distance between ground truth vertices V_{GT} and predicted vertices V:

$${L}_{vert} = {L}_{1} ( V , {V}_{GT} ) \qquad ( 7 )$$

The total loss calculation for the human mesh estimation model 122 during training may be formed from a weighted sum of these losses:

$$L = {w}_{shape} \cdot {L}_{shape} + {w}_{pose} \cdot {L}_{pose} + {w}_{joint} \cdot {L}_{joint} + {w}_{vert} \cdot {L}_{vert} \qquad ( 8 )$$

In one embodiment, wₛₕₐₚₑ=1, wₚₒₛₑ=1, wⱼₒᵢₙₜ=5, wᵥₑᵣₜ=5 to balance the magnitudes of the different losses.

Once T_{z} is fixed, the XY-translations [Tₓ, T_{y}] control the position of the mesh in the z=T_{z} plane. Focal distance f controls the scale of the image.

These parameters may be determined by the camera solver 136 for a predicted T_{z} using a differentiable rasterizer 138. The predicted mesh may be rendered with an initial translation T=[0, 0, T_{z}] and an initial focal length (e.g., equal to the image height fᵢₙᵢₜ=h). For example, a SMPL-X estimated human body mesh and orientation 104 may be rasterized as a binary mask 140, where pixels are 1 for the projected mesh surface and 0 otherwise. The predicted mesh already incorporates the estimated orientation so it is unnecessary to apply extra rotation to the mesh. The differentiable rasterizer 138 may optimize for a tensor (f, Tₓ, T_{y}) that maximizes the intersection-over-union between the rasterized SMPL-X mask of the estimated mesh 140 and a mask of the depicted person 142 in the image. The mask of the depicted person 142 may be generated using a conventional segmentation model 144, e.g., Segment Anything Model (SAM).

Additionally, the differentiable rasterizer may minimize the distance between the projected joints and keypoints of the human mesh and joints and keypoints detected from the image. Human joints and keypoints may be detected from the input original image 102 using conventional keypoint detectors. In addition to the focal length and XY-translations (f, Tₓ, T_{y}), other parameters including T_{z} maybe optionally optimized.

To ensure smooth gradient flow over the entire image, Gaussian smoothing may be applied to both the mask of the estimated mesh 140 and the mask of the depicted person 142. The estimated human body mesh and orientation 104 may be shifted such that its projection aligns with the person depicted in the image, and the camera focal length may be adjusted to align the sizes of the mask of the estimated mesh 140 and the mask of the depicted person 142, yielding the final estimated projection 146.

The pelvis depth estimator 108 F^{T}^{_{z}} and the human mesh estimation model 122 F^{pose} may be trained in two stages. During the first stage, the pelvis depth estimator 108 F^{T}^{_{z}} may be trained. In the second training stage, the parameters of F^{Tis z} may be frozen and its predictions of T_{z} fed to the human mesh estimation model 122 F^{pose}. The optimization of focal length and translation vector T=[Tₓ, T_{y}, T_{z}] may not involve training.

The mechanisms disclosed herein may be implemented in and/or by computing devices utilizing one or more graphic processing unit (GPU) and/or general purpose data processor (e.g., a “central processing unit” or CPU). For example, a memory 220/main memory 704 may be configured with instructions that when executed by one or more data processor (e.g, parallel processing unit 202, parallel processing module 606, central processing unit 602) configure a system to implement the disclosed mechanisms. A graphics processing unit comprises at least one parallel processing unit and may be a standalone chip or package, or may comprise graphics processing circuitry integrated with a central processing unit. Exemplary architectures will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

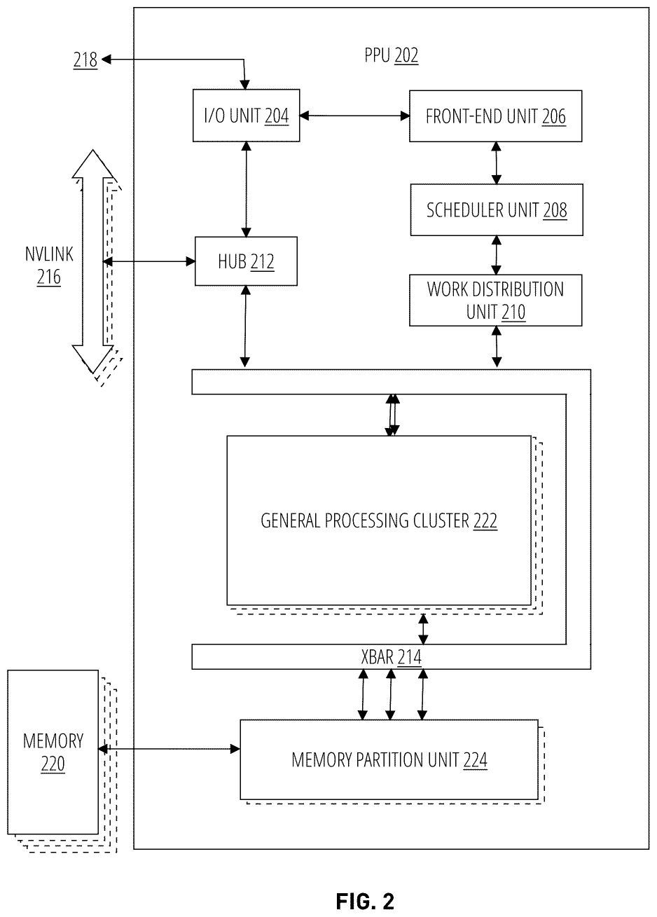

FIG. 2 depicts a parallel processing unit 202, in accordance with an embodiment. In an embodiment, the parallel processing unit 202 is a multi-threaded processor that is implemented on one or more integrated circuit devices. The parallel processing unit 202 is a latency hiding architecture designed to process many threads in parallel. A thread (e.g., a thread of execution) is an instantiation of a set of instructions configured to be executed by the parallel processing unit 202. In an embodiment, the parallel processing unit 202 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 202 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 202 modules may be configured to accelerate thousands of High Performance Computing (HPC), data center, and machine learning applications. The parallel processing unit 202 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 2, the parallel processing unit 202 includes an I/O unit 204, a front-end unit 206, a scheduler unit 208, a work distribution unit 210, a hub 212, a crossbar 214, one or more general processing cluster 222 modules, and one or more memory partition unit 224 modules. The parallel processing unit 202 may be connected to a host processor or other parallel processing unit 202 modules via one or more high-speed NVLink 216 interconnects. The parallel processing unit 202 may be connected to a host processor or other peripheral devices via an interconnect 218. The parallel processing unit 202 may also be connected to a local memory comprising a number of memory 220 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 220 may comprise logic to configure the parallel processing unit 202 to carry out aspects of the techniques disclosed herein.

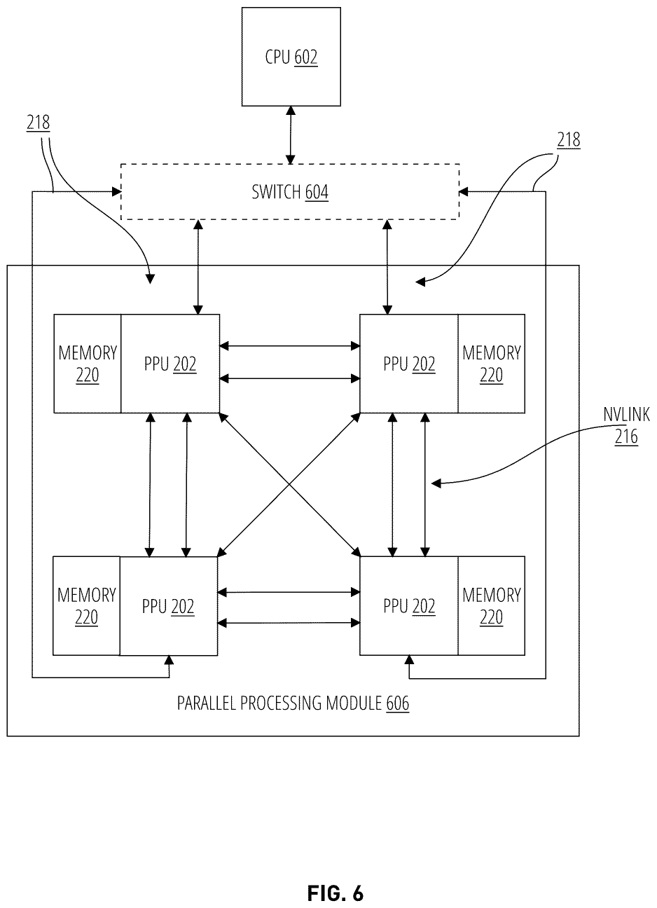

The NVLink 216 interconnect enables systems to scale and include one or more parallel processing unit 202 modules combined with one or more CPUs, supports cache coherence between the parallel processing unit 202 modules and CPUs, and CPU mastering. Data and/or commands may be transmitted by the NVLink 216 through the hub 212 to/from other units of the parallel processing unit 202 such as one or more copy engines, a video encoder, a video decoder, a power management unit, etc. (not explicitly shown). The NVLink 216 is described in more detail in conjunction with FIG. 6.

The I/O unit 204 is configured to transmit and receive communications (e.g., commands, data, etc.) from a host processor (not shown) over the interconnect 218. The I/O unit 204 may communicate with the host processor directly via the interconnect 218 or through one or more intermediate devices such as a memory bridge. In an embodiment, the I/O unit 204 may communicate with one or more other processors, such as one or more parallel processing unit 202 modules via the interconnect 218. In an embodiment, the I/O unit 204 implements a Peripheral Component Interconnect Express (PCIe) interface for communications over a PCIe bus and the interconnect 218 is a PCIe bus. In alternative embodiments, the I/O unit 204 may implement other types of well-known interfaces for communicating with external devices.

The I/O unit 204 decodes packets received via the interconnect 218. In an embodiment, the packets represent commands configured to cause the parallel processing unit 202 to perform various operations. The I/O unit 204 transmits the decoded commands to various other units of the parallel processing unit 202 as the commands may specify. For example, some commands may be transmitted to the front-end unit 206. Other commands may be transmitted to the hub 212 or other units of the parallel processing unit 202 such as one or more copy engines, a video encoder, a video decoder, a power management unit, etc. (not explicitly shown). In other words, the I/O unit 204 is configured to route communications between and among the various logical units of the parallel processing unit 202.

In an embodiment, a program executed by the host processor encodes a command stream in a buffer that provides workloads to the parallel processing unit 202 for processing. A workload may comprise several instructions and data to be processed by those instructions. The buffer is a region in a memory that is accessible (e.g., read/write) by both the host processor and the parallel processing unit 202. For example, the I/O unit 204 may be configured to access the buffer in a system memory connected to the interconnect 218 via memory requests transmitted over the interconnect 218. In an embodiment, the host processor writes the command stream to the buffer and then transmits a pointer to the start of the command stream to the parallel processing unit 202. The front-end unit 206 receives pointers to one or more command streams. The front-end unit 206 manages the one or more streams, reading commands from the streams and forwarding commands to the various units of the parallel processing unit 202.

The front-end unit 206 is coupled to a scheduler unit 208 that configures the various general processing cluster 222 modules to process tasks defined by the one or more streams. The scheduler unit 208 is configured to track state information related to the various tasks managed by the scheduler unit 208. The state may indicate which general processing cluster 222 a task is assigned to, whether the task is active or inactive, a priority level associated with the task, and so forth. The scheduler unit 208 manages the execution of a plurality of tasks on the one or more general processing cluster 222 modules.

The scheduler unit 208 is coupled to a work distribution unit 210 that is configured to dispatch tasks for execution on the general processing cluster 222 modules. The work distribution unit 210 may track a number of scheduled tasks received from the scheduler unit 208. In an embodiment, the work distribution unit 210 manages a pending task pool and an active task pool for each of the general processing cluster 222 modules. The pending task pool may comprise a number of slots (e.g., 32 slots) that contain tasks assigned to be processed by a particular general processing cluster 222. The active task pool may comprise a number of slots (e.g., 4 slots) for tasks that are actively being processed by the general processing cluster 222 modules. As a general processing cluster 222 finishes the execution of a task, that task is evicted from the active task pool for the general processing cluster 222 and one of the other tasks from the pending task pool is selected and scheduled for execution on the general processing cluster 222. If an active task has been idle on the general processing cluster 222, such as while waiting for a data dependency to be resolved, then the active task may be evicted from the general processing cluster 222 and returned to the pending task pool while another task in the pending task pool is selected and scheduled for execution on the general processing cluster 222.

The work distribution unit 210 communicates with the one or more general processing cluster 222 modules via crossbar 214. The crossbar 214 is an interconnect network that couples many of the units of the parallel processing unit 202 to other units of the parallel processing unit 202. For example, the crossbar 214 may be configured to couple the work distribution unit 210 to a particular general processing cluster 222. Although not shown explicitly, one or more other units of the parallel processing unit 202 may also be connected to the crossbar 214 via the hub 212.

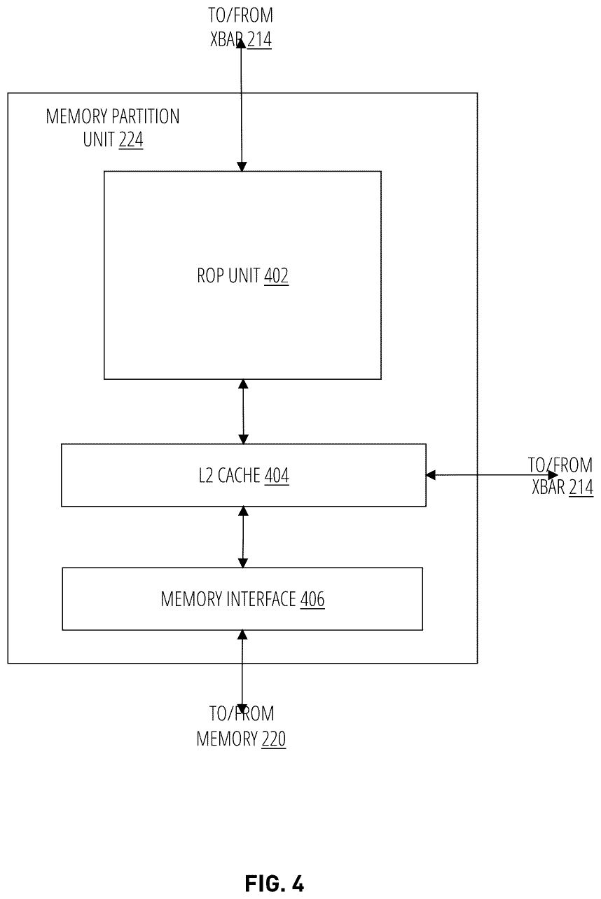

The tasks are managed by the scheduler unit 208 and dispatched to a general processing cluster 222 by the work distribution unit 210. The general processing cluster 222 is configured to process the task and generate results. The results may be consumed by other tasks within the general processing cluster 222, routed to a different general processing cluster 222 via the crossbar 214, or stored in the memory 220. The results can be written to the memory 220 via the memory partition unit 224 modules, which implement a memory interface for reading and writing data to/from the memory 220. The results can be transmitted to another parallel processing unit 202 or CPU via the NVLink 216. In an embodiment, the parallel processing unit 202 includes a number U of memory partition unit 224 modules that is equal to the number of separate and distinct memory 220 devices coupled to the parallel processing unit 202. A memory partition unit 224 will be described in more detail below in conjunction with FIG. 4.

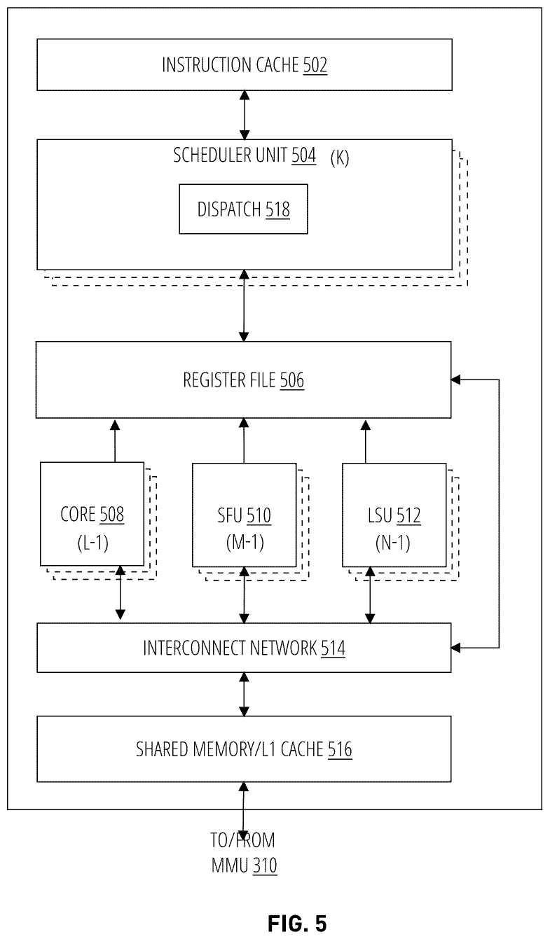

In an embodiment, a host processor executes a driver kernel that implements an application programming interface (API) that enables one or more applications executing on the host processor to schedule operations for execution on the parallel processing unit 202. In an embodiment, multiple compute applications are simultaneously executed by the parallel processing unit 202 and the parallel processing unit 202 provides isolation, quality of service (QoS), and independent address spaces for the multiple compute applications. An application may generate instructions (e.g., API calls) that cause the driver kernel to generate one or more tasks for execution by the parallel processing unit 202. The driver kernel outputs tasks to one or more streams being processed by the parallel processing unit 202. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 5.

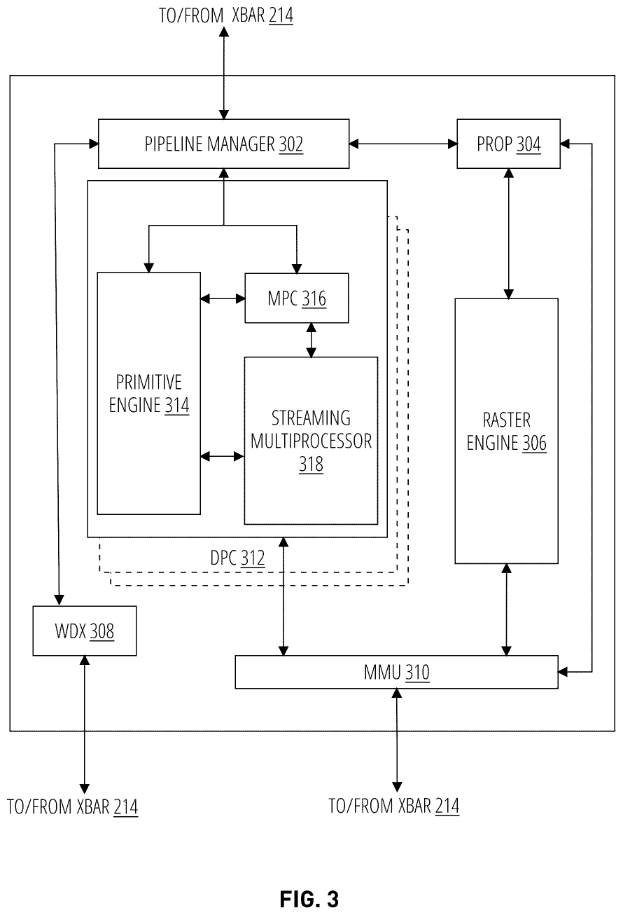

FIG. 3 depicts a general processing cluster 222 of the parallel processing unit 202 of FIG. 2, in accordance with an embodiment. As shown in FIG. 3, each general processing cluster 222 includes a number of hardware units for processing tasks. In an embodiment, each general processing cluster 222 includes a pipeline manager 302, a pre-raster operations unit 304, a raster engine 306, a work distribution crossbar 308, a memory management unit 310, and one or more data processing cluster 312. It will be appreciated that the general processing cluster 222 of FIG. 3 may include other hardware units in lieu of or in addition to the units shown in FIG. 3.

In an embodiment, the operation of the general processing cluster 222 is controlled by the pipeline manager 302. The pipeline manager 302 manages the configuration of the one or more data processing cluster 312 modules for processing tasks allocated to the general processing cluster 222. In an embodiment, the pipeline manager 302 may configure at least one of the one or more data processing cluster 312 modules to implement at least a portion of a graphics rendering pipeline. For example, a data processing cluster 312 may be configured to execute a vertex shader program on the programmable streaming multiprocessor 318. The pipeline manager 302 may also be configured to route packets received from the work distribution unit 210 to the appropriate logical units within the general processing cluster 222. For example, some packets may be routed to fixed function hardware units in the pre-raster operations unit 304 and/or raster engine 306 while other packets may be routed to the data processing cluster 312 modules for processing by the primitive engine 314 or the streaming multiprocessor 318. In an embodiment, the pipeline manager 302 may configure at least one of the one or more data processing cluster 312 modules to implement a neural network model and/or a computing pipeline.

The pre-raster operations unit 304 is configured to route data generated by the raster engine 306 and the data processing cluster 312 modules to a Raster Operations (ROP) unit, described in more detail in conjunction with FIG. 4. The pre-raster operations unit 304 may also be configured to perform optimizations for color blending, organize pixel data, perform address translations, and the like.

The raster engine 306 includes a number of fixed function hardware units configured to perform various raster operations. In an embodiment, the raster engine 306 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 306 comprises fragments to be processed, for example, by a fragment shader implemented within a data processing cluster 312.

Each data processing cluster 312 included in the general processing cluster 222 includes an M-pipe controller 316, a primitive engine 314, and one or more streaming multiprocessor 318 modules. The M-pipe controller 316 controls the operation of the data processing cluster 312, routing packets received from the pipeline manager 302 to the appropriate units in the data processing cluster 312. For example, packets associated with a vertex may be routed to the primitive engine 314, which is configured to fetch vertex attributes associated with the vertex from the memory 220. In contrast, packets associated with a shader program may be transmitted to the streaming multiprocessor 318.

The streaming multiprocessor 318 comprises a programmable streaming processor that is configured to process tasks represented by a number of threads. Each streaming multiprocessor 318 is multi-threaded and configured to execute a plurality of threads (e.g., 32 threads) from a particular group of threads concurrently. In an embodiment, the streaming multiprocessor 318 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 318 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 318 will be described in more detail below in conjunction with FIG. 5.

The memory management unit 310 provides an interface between the general processing cluster 222 and the memory partition unit 224. The memory management unit 310 may provide translation of virtual addresses into physical addresses, memory protection, and arbitration of memory requests. In an embodiment, the memory management unit 310 provides one or more translation lookaside buffers (TLBs) for performing translation of virtual addresses into physical addresses in the memory 220.

FIG. 4 depicts a memory partition unit 224 of the parallel processing unit 202 of FIG. 2, in accordance with an embodiment. As shown in FIG. 4, the memory partition unit 224 includes a raster operations unit 402, a level two cache 404, and a memory interface 406. The memory interface 406 is coupled to the memory 220. Memory interface 406 may implement 32, 64, 128, 1024-bit data buses, or the like, for high-speed data transfer. In an embodiment, the parallel processing unit 202 incorporates U memory interface 406 modules, one memory interface 406 per pair of memory partition unit 224 modules, where each pair of memory partition unit 224 modules is connected to a corresponding memory 220 device. For example, parallel processing unit 202 may be connected to up to Y memory 220 devices, such as high bandwidth memory stacks or graphics double-data-rate, version 5, synchronous dynamic random access memory, or other types of persistent storage.

In an embodiment, the memory interface 406 implements an HBM2 memory interface and Y equals half U. In an embodiment, the HBM2 memory stacks are located on the same physical package as the parallel processing unit 202, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 220 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 202 modules process very large datasets and/or run applications for extended periods.

In an embodiment, the parallel processing unit 202 implements a multi-level memory hierarchy. In an embodiment, the memory partition unit 224 supports a unified memory to provide a single unified virtual address space for CPU and parallel processing unit 202 memory, enabling data sharing between virtual memory systems. In an embodiment the frequency of accesses by a parallel processing unit 202 to memory located on other processors is traced to ensure that memory pages are moved to the physical memory of the parallel processing unit 202 that is accessing the pages more frequently. In an embodiment, the NVLink 216 supports address translation services allowing the parallel processing unit 202 to directly access a CPU's page tables and providing full access to CPU memory by the parallel processing unit 202.

In an embodiment, copy engines transfer data between multiple parallel processing unit 202 modules or between parallel processing unit 202 modules and CPUs. The copy engines can generate page faults for addresses that are not mapped into the page tables. The memory partition unit 224 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 220 or other system memory may be fetched by the memory partition unit 224 and stored in the level two cache 404, which is located on-chip and is shared between the various general processing cluster 222 modules. As shown, each memory partition unit 224 includes a portion of the level two cache 404 associated with a corresponding memory 220 device. Lower level caches may then be implemented in various units within the general processing cluster 222 modules. For example, each of the streaming multiprocessor 318 modules may implement an L1 cache. The L1 cache is private memory that is dedicated to a particular streaming multiprocessor 318. Data from the level two cache 404 may be fetched and stored in each of the L1 caches for processing in the functional units of the streaming multiprocessor 318 modules. The level two cache 404 is coupled to the memory interface 406 and the crossbar 214.

The raster operations unit 402 performs graphics raster operations related to pixel color, such as color compression, pixel blending, and the like. The raster operations unit 402 also implements depth testing in conjunction with the raster engine 306, receiving a depth for a sample location associated with a pixel fragment from the culling engine of the raster engine 306. The depth is tested against a corresponding depth in a depth buffer for a sample location associated with the fragment. If the fragment passes the depth test for the sample location, then the raster operations unit 402 updates the depth buffer and transmits a result of the depth test to the raster engine 306. It will be appreciated that the number of partition memory partition unit 224 modules may be different than the number of general processing cluster 222 modules and, therefore, each raster operations unit 402 may be coupled to each of the general processing cluster 222 modules. The raster operations unit 402 tracks packets received from the different general processing cluster 222 modules and determines which general processing cluster 1 that a result generated by the raster operations unit 402 is routed to through the crossbar 214. Although the raster operations unit 402 is included within the memory partition unit 224 in FIG. 4, in other embodiment, the raster operations unit 402 may be outside of the memory partition unit 224. For example, the raster operations unit 402 may reside in the general processing cluster 222 or another unit.

FIG. 5 illustrates the streaming multiprocessor 318 of FIG. 3, in accordance with an embodiment. As shown in FIG. 5, the streaming multiprocessor 318 includes an instruction cache 502, one or more scheduler unit 504 modules (e.g., such as scheduler unit 208), a register file 506, one or more processing core 508 modules, one or more special function unit 510 modules, one or more load/store unit 512 modules, an interconnect network 514, and a shared memory/L1 cache 516.

As described above, the work distribution unit 210 dispatches tasks for execution on the general processing cluster 222 modules of the parallel processing unit 202. The tasks are allocated to a particular data processing cluster 312 within a general processing cluster 222 and, if the task is associated with a shader program, the task may be allocated to a streaming multiprocessor 318. The scheduler unit 208 receives the tasks from the work distribution unit 210 and manages instruction scheduling for one or more thread blocks assigned to the streaming multiprocessor 318. The scheduler unit 504 schedules thread blocks for execution as warps of parallel threads, where each thread block is allocated at least one warp. In an embodiment, each warp executes 32 threads. The scheduler unit 504 may manage a plurality of different thread blocks, allocating the warps to the different thread blocks and then dispatching instructions from the plurality of different cooperative groups to the various functional units (e.g., core 508 modules, special function unit 510 modules, and load/store unit 512 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 518 unit is configured within the scheduler unit 504 to transmit instructions to one or more of the functional units. In one embodiment, the scheduler unit 504 includes two dispatch 518 units that enable two different instructions from the same warp to be dispatched during each clock cycle. In alternative embodiments, each scheduler unit 504 may include a single dispatch 518 unit or additional dispatch 518 units.

Each streaming multiprocessor 318 includes a register file 506 that provides a set of registers for the functional units of the streaming multiprocessor 318. In an embodiment, the register file 506 is divided between each of the functional units such that each functional unit is allocated a dedicated portion of the register file 506. In another embodiment, the register file 506 is divided between the different warps being executed by the streaming multiprocessor 318. The register file 506 provides temporary storage for operands connected to the data paths of the functional units.

Each streaming multiprocessor 318 comprises L processing core 508 modules. In an embodiment, the streaming multiprocessor 318 includes a large number (e.g., 128, etc.) of distinct processing core 508 modules. Each core 508 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 508 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 508 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 318 also comprises M special function unit 510 modules that perform special functions (e.g., attribute evaluation, reciprocal square root, and the like). In an embodiment, the special function unit 510 modules may include a tree traversal unit configured to traverse a hierarchical tree data structure. In an embodiment, the special function unit 510 modules may include texture unit configured to perform texture map filtering operations. In an embodiment, the texture units are configured to load texture maps (e.g., a 2D array of texels) from the memory 220 and sample the texture maps to produce sampled texture values for use in shader programs executed by the streaming multiprocessor 318. In an embodiment, the texture maps are stored in the shared memory/L1 cache 516. The texture units implement texture operations such as filtering operations using mip-maps (e.g., texture maps of varying levels of detail). In an embodiment, each streaming multiprocessor 318 includes two texture units.

Each streaming multiprocessor 318 also comprises N load/store unit 512 modules that implement load and store operations between the shared memory/L1 cache 516 and the register file 506. Each streaming multiprocessor 318 includes an interconnect network 514 that connects each of the functional units to the register file 506 and the load/store unit 512 to the register file 506 and shared memory/L1 cache 516. In an embodiment, the interconnect network 514 is a crossbar that can be configured to connect any of the functional units to any of the registers in the register file 506 and connect the load/store unit 512 modules to the register file 506 and memory locations in shared memory/L1 cache 516.

The shared memory/L1 cache 516 is an array of on-chip memory that allows for data storage and communication between the streaming multiprocessor 318 and the primitive engine 314 and between threads in the streaming multiprocessor 318. In an embodiment, the shared memory/L1 cache 516 comprises 128 KB of storage capacity and is in the path from the streaming multiprocessor 318 to the memory partition unit 224. The shared memory/L1 cache 516 can be used to cache reads and writes. One or more of the shared memory/L1 cache 516, level two cache 404, and memory 220 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 516 enables the shared memory/L1 cache 516 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 2, are bypassed, creating a much simpler programming model. In the general purpose parallel computation configuration, the work distribution unit 210 assigns and distributes blocks of threads directly to the data processing cluster 312 modules. The threads in a block execute the same program, using a unique thread ID in the calculation to ensure each thread generates unique results, using the streaming multiprocessor 318 to execute the program and perform calculations, shared memory/L1 cache 516 to communicate between threads, and the load/store unit 512 to read and write global memory through the shared memory/L1 cache 516 and the memory partition unit 224. When configured for general purpose parallel computation, the streaming multiprocessor 318 can also write commands that the scheduler unit 208 can use to launch new work on the data processing cluster 312 modules.

The parallel processing unit 202 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 202 is embodied on a single semiconductor substrate. In another embodiment, the parallel processing unit 202 is included in a system-on-a-chip (SoC) along with one or more other devices such as additional parallel processing unit 202 modules, the memory 220, a reduced instruction set computer (RISC) CPU, a memory management unit (MMU), a digital-to-analog converter (DAC), and the like.

In an embodiment, the parallel processing unit 202 may be included on a graphics card that includes one or more memory devices. The graphics card may be configured to interface with a PCIe slot on a motherboard of a desktop computer. In yet another embodiment, the parallel processing unit 202 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 6 is a conceptual diagram of a processing system implemented using the parallel processing unit 202 of FIG. 2, in accordance with an embodiment. The processing system includes a central processing unit 602, an switch 604, and multiple parallel processing unit 202 modules each and respective memory 220 modules. The switch 604 is depicted with dashed lines, indicating that it is optional in some embodiments.

The NVLink 216 provides high-speed communication links between each of the parallel processing unit 202 modules. Although a particular number of NVLink 216 and interconnect 218 connections are illustrated in FIG. 6, the number of connections to each parallel processing unit 202 and the central processing unit 602 may vary. The switch 604 interfaces between the interconnect 218 and the central processing unit 602. The parallel processing unit 202 modules, memory 220 modules, and NVLink 216 connections may be situated on a single semiconductor platform to form a parallel processing module 606. In an embodiment, the switch 604 supports two or more protocols to interface between various different connections and/or links.

In another embodiment (not shown), the NVLink 216 provides one or more high-speed communication links between each of the parallel processing unit modules (parallel processing unit 202, parallel processing unit 202, parallel processing unit 202, and parallel processing unit 202) and the central processing unit 602 and the switch 604 (when present) interfaces between the interconnect 218 and each of the parallel processing unit modules. The parallel processing unit modules, memory 220 modules, and interconnect 218 may be situated on a single semiconductor platform to form a parallel processing module 606. In yet another embodiment (not shown), the interconnect 218 provides one or more communication links between each of the parallel processing unit modules and the central processing unit 602 and the switch 604 interfaces between each of the parallel processing unit modules using the NVLink 216 to provide one or more high-speed communication links between the parallel processing unit modules. In another embodiment (not shown), the NVLink 216 provides one or more high-speed communication links between the parallel processing unit modules and the central processing unit 602 through the switch 604. In yet another embodiment (not shown), the interconnect 218 provides one or more communication links between each of the parallel processing unit modules directly. One or more of the NVLink 216 high-speed communication links may be implemented as a physical NVLink interconnect or either an on-chip or on-die interconnect using the same protocol as the NVLink 216.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 606 may be implemented as a circuit board substrate and each of the parallel processing unit modules and/or memory 220 modules may be packaged devices. In an embodiment, the central processing unit 602, switch 604, and the parallel processing module 606 are situated on a single semiconductor platform.

In an embodiment, each parallel processing unit module includes six NVLink 216 interfaces (as shown in FIG. 6, five NVLink 216 interfaces are included for each parallel processing unit module). The NVLink 216 may be operated exclusively for PPU-to-PPU communication as shown in FIG. 6, or some combination of PPU-to-PPU and PPU-to-CPU, when the central processing unit 602 also includes one or more NVLink 216 interfaces.

In an embodiment, the NVLink 216 allows direct load/store/atomic access from the central processing unit 602 to each parallel processing unit module's memory 220. In an embodiment, the NVLink 216 supports coherency operations, allowing data read from the memory 220 modules to be stored in the cache hierarchy of the central processing unit 602, reducing cache access latency for the central processing unit 602. In an embodiment, the NVLink 216 includes support for Address Translation Services (ATS), enabling the parallel processing unit module to directly access page tables within the central processing unit 602. One or more of the NVLink 216 may also be configured to operate in a low-power mode.

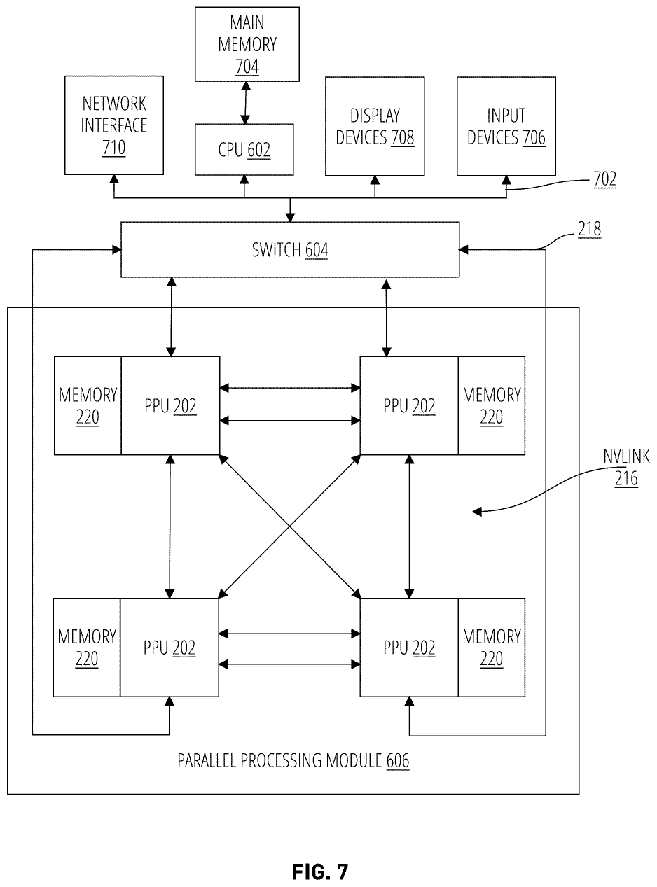

FIG. 7 depicts an exemplary processing system in which the various architecture and/or functionality of the various previous embodiments may be implemented. As shown, an exemplary processing system is provided including at least one central processing unit 602 that is connected to a communications bus 702. The communication communications bus 702 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 704. Control logic (software) and data are stored in the main memory 704 which may take the form of random access memory (RAM). For simplicity of illustration, the main memory 704 may be understood to comprise other forms of bulk memory, including non-volatile memory technologies.

The exemplary processing system also includes input devices 706, the parallel processing module 606, and display devices 708, e.g. a conventional CRT (cathode ray tube), LCD (liquid crystal display), LED (light emitting diode), plasma display or the like. User input may be received from the input devices 706, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 710 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage. Such computer programs, when executed, enable the exemplary processing system to perform various functions. The main memory 704, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

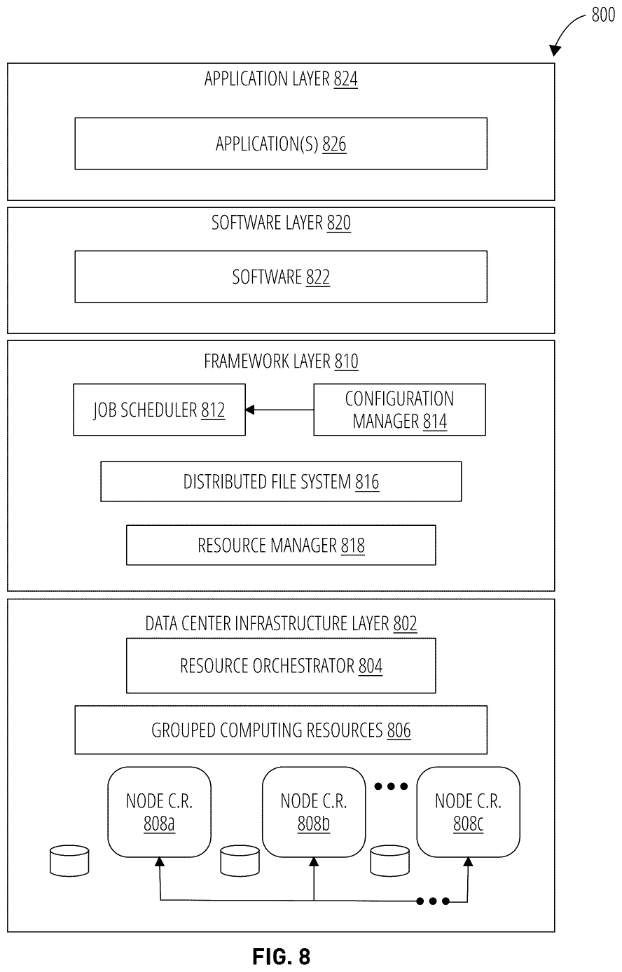

FIG. 8 depicts an exemplary data center 800 that may be configured (e.g., with memory comprising one or more application(s) 826) to implement the disclosed mechanisms, in accordance with at least one embodiment. In at least one embodiment, data center 800 includes, without limitation, a data center infrastructure layer 802, a framework layer 810, a software layer 820, and an application layer 824.

In at least one embodiment, as depicted in FIG. 8, data center infrastructure layer 802 may include a resource orchestrator 804, grouped computing resources 806, and node computing resources (node C.R.s) 808a, 808b, 808c, where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices (e.g., dynamic read-only memory), storage devices (e.g., solid state or disk drives), network input/output (NW I/O) devices, network switches, virtual machines (VMs), power modules, and cooling modules, etc. In at least one embodiment, one or more node computing resources from among node computing resources 808a, 808b, 808c may be a server having one or more of the above-mentioned computing resources.

In at least one embodiment, grouped computing resources 806 may include separate groupings of node computing resources housed within one or more racks (not shown), or many racks housed in data centers at various geographical locations (also not shown). Separate groupings of node computing resources within grouped computing resources 806 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 804 may configure or otherwise control one or more node computing resources 808a, 808b, 808c and/or grouped computing resources 806. In at least one embodiment, resource orchestrator 804 may include a software design infrastructure (“SDI”) management entity for data center 800. In at least one embodiment, resource orchestrator 804 may include hardware, software, or some combination thereof.

In at least one embodiment, as depicted in FIG. 8, framework layer 810 includes, without limitation, a job scheduler 812, a configuration manager 814, a resource manager 818, and a distributed file system 816. In at least one embodiment, framework layer 810 may include a framework to support software 822 of software layer 820 and/or one or more application(s) 826 of application layer 220. In at least one embodiment, software 822 or application(s) 826 may respectively include web-based service software or applications, such as those provided by Amazon Web Services, Google Cloud, and Microsoft Azure. In at least one embodiment, framework layer 810 may be, but is not limited to, a type of free and open-source software web application framework such as Apache SPARK™ (hereinafter “Spark) that may utilize a distributed file system 816 for large-scale data processing (e.g., “big data”). In at least one embodiment, job scheduler 812 may include a Spark driver to facilitate scheduling of workloads supported by various layers of data center 800. In at least one embodiment, configuration manager 814 may be capable of configuring different layers such as software layer 820 and framework layer 810, including Spark and distributed file system 816 for supporting large-scale data processing. In at least one embodiment, resource manager 818 may be capable of managing clustered or grouped computing resources mapped to or allocated for support of distributed file system 816 and job scheduler 812. In at least one embodiment, clustered or grouped computing resources may include grouped computing resources 806 at data center infrastructure layer 802. In at least one embodiment, resource manager 818 may coordinate with resource orchestrator 804 to manage these mapped or allocated computing resources.

In at least one embodiment, software 822 included in software layer 820 may include software used by at least portions of node computing resources 808a, 808b, 808c, grouped computing resources 806, and/or distributed file system 816 of framework layer 810. One or more types of software may include, but are not limited to, Internet web page search software, e-mail virus scan software, database software, and streaming video content software.

In at least one embodiment, application(s) 826 included in application layer 824 may include one or more types of applications used by at least portions of node computing resources 808a, 808b, 808c, grouped computing resources 806, and/or distributed file system 816 of framework layer 810. In at least one or more types of applications may include, without limitation, Compute Unified Device Architecture (CUDA) applications, 5G network applications, artificial intelligence applications, data center applications, and/or variations thereof.

In at least one embodiment, any of configuration manager 814, resource manager 818, and resource orchestrator 804 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poorly performing portions of a data center.

### LISTING OF DRAWING ELEMENTS

102 original image
104 estimated human body mesh and orientation
106 parametric human mesh generation function
108 pelvis depth estimator
110 cropped image
112 image cropper
114 depth estimation model
116 depth features
118 convolutional neural network
120 transformer model
122 human mesh estimation model
124 pretrained human mesh estimation model
126 pelvis depth encoder
128 trainable copy of the pretrained human mesh estimation model
130 multilayer perceptron
132 transformer model
134 multilayer perceptron
136 camera solver
138 differentiable rasterizer
140 mask of the estimated mesh
142 mask of the depicted person
144 segmentation model
146 final estimated projection
202 parallel processing unit
204 I/O unit
206 front-end unit
208 scheduler unit
210 work distribution unit
212 hub
214 crossbar
216 NVLink
218 interconnect
220 memory
222 general processing cluster
224 memory partition unit
302 pipeline manager
304 pre-raster operations unit
306 raster engine
308 work distribution crossbar
310 memory management unit
312 data processing cluster
314 primitive engine
316 M-pipe controller
318 streaming multiprocessor
402 raster operations unit
404 level two cache
406 memory interface
502 instruction cache
504 scheduler unit
506 register file
508 core
510 special function unit
512 load/store unit
514 interconnect network
516 shared memory/L1 cache
518 dispatch
602 central processing unit
604 switch
606 parallel processing module
702 communications bus
704 main memory
706 input devices
708 display devices
710 network interface
800 data center
802 data center infrastructure layer
804 resource orchestrator
806 grouped computing resources
808a node computing resource
808b node computing resource
808c node computing resource
810 framework layer
812 job scheduler
814 configuration manager
816 distributed file system
818 resource manager
820 software layer
822 software
824 application layer
826 application(s)

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system comprising:
a human mesh estimation model configured to generate a body mesh corresponding to a person depicted in an image;
a pelvis depth estimation model configured to generate a pelvis depth estimate of the person depicted in the image; and
a camera solver configured to estimate camera parameters for the image based on the body mesh and the pelvis depth estimate.

2. The system of claim 1, wherein the human mesh estimation model is configured to be conditioned on the pelvis depth estimate.

3. The system of claim 1, wherein the pelvis depth estimation model comprises a depth estimation model configured to generate depth features for the image.

4. The system of claim 3, wherein the pelvis depth estimation model further comprises a neural network configured to transform the depth features into the pelvis depth estimate.

5. The system of claim 4, wherein the neural network comprises a transformer configured to transform the depth features set into the pelvis depth estimate.

6. The system of claim 1, wherein the human mesh estimation model comprises a pretrained human mesh estimation model and a trainable copy of the pretrained human mesh estimation model.

7. The system of claim 6, wherein the trainable copy of the pretrained human mesh estimation model is configured to receive the pelvis depth estimate as a conditioning input.

8. The system of claim 6, wherein the human mesh estimation model is configured to combine outputs of the pretrained human mesh estimation model and the trainable copy of the pretrained human mesh estimation model.

9. The system of claim 6, wherein the human mesh estimation model is configured to process an output of the pretrained human mesh estimation model through a multilayer perceptron before the outputs of the pretrained human mesh estimation model and the trainable copy of the pretrained human mesh estimation model are combined.

10. The system of claim 6, wherein the human mesh estimation model comprises a pelvis depth encoder configured to receive the pelvis depth estimate from the pelvis depth estimation model.

11. The system of claim 10, wherein the human mesh estimation model further comprises a plurality of multilayer perceptrons configured to condition output of the trainable copy of the pretrained human mesh estimation model on the pelvis depth estimate.

12. The system of claim 6, wherein the human mesh estimation model further comprises a transformer model configured to transform outputs from the pretrained human mesh estimation model and the trainable copy of the pretrained human mesh estimation model into human shape and pose parameters.

13. The system of claim 12, wherein the human mesh estimation model further comprises a parametric human mesh generation function configured to transform the human shape and pose parameters into the body mesh.

14. The system of claim 1, wherein the camera solver comprises a differentiable rasterizer configured to transform the body mesh into a mask.

15. The system of claim 14, wherein the camera solver is configured to condition the differentiable rasterizer on the pelvis depth estimate.

16. The system of claim 14, wherein the differentiable rasterizer is configured to maximize an intersection-over-union between the mask of the body mesh and a mask of the person depicted in the image.

17. The system of claim 14, wherein the differentiable rasterizer in configured to minimize a distance between projected joints and keypoints of the body mesh and joints and keypoints detected from the image.

18. A system comprising:
a pelvis depth estimation model configured to generate a pelvis depth estimate of a person depicted in an image;
a human mesh estimation model configured to generate a body mesh corresponding to the person depicted in the image based on the estimated pelvis depth; and
a camera solver configured to apply differentiable rasterization to derive camera translation and focal length parameters for the image.

19. A process for determining camera intrinsic and extrinsic parameters for an image, the process comprising:
operating a pelvis depth estimation model to generate a pelvis depth estimate of a person depicted in the image;
operating a human mesh estimation model to generate a body mesh corresponding to the person depicted in the image based on the estimated pelvis depth; and
applying differentiable rasterization to the body mesh to derive the camera intrinsic and extrinsic parameters.
